(19) United States
(12) Patent Application Publication
(10) Pub. No.: US 2025/0184459 A1
(43) Pub. Date: Jun. 5, 2025

(54) IMAGE GENERATION APPARATUS AND IMAGE GENERATION METHOD

(71) Applicant: Panasonic Automotive Systems Co., Ltd., Kanagawa (JP)

(72) Inventors: Yudai ISHIBASHI, Kanagawa Ken (JP); Masayoshi MICHIGUCHI, Kanagawa Ken (JP)

(73) Assignee: Panasonic Automotive Systems Co., Ltd., Kanagawa (JP)

(21) Appl. No.: 18/929,108

(22) Filed: Oct. 28, 2024

(30) Foreign Application Priority Data
Dec. 5, 2023 (JP) 2023-205109

(51) Int. Cl. H04N 13/117; G06V 20/56; H04N 13/156; H04N 13/383

(52) U.S. Cl. CPC H04N 13/117; G06V 20/56; H04N 13/156; H04N 13/383

(57) ABSTRACT

An image generation apparatus according to the present disclosure includes a processor that acquires a first image in which a surrounding environment of a vehicle imaged by an imaging apparatus provided in the vehicle is shown, generates, based on the first image, a plurality of second images corresponding to horizontal components viewed from a virtual viewpoint provided above the vehicle in a plurality of line-of-sight directions that are shifted in a direction of rotation around the vehicle and are different from each other, and switches and outputs the plurality of second images to a display device.

### CROSS-REFERENCE TO RELATED APPLICATIONS

This application is based upon and claims the benefit of priority from Japanese Patent Application No. 2023-205109, filed on Dec. 5, 2023, the entire contents of which are incorporated herein by reference.

### FIELD

The present disclosure relates to an image generation apparatus and an image generation method.

### BACKGROUND

In the related art, there is a technology in which a virtual viewpoint is arranged outside a vehicle, an image in which the surrounding of the vehicle viewed from the virtual viewpoint is generated, and the generated image is displayed on a display device in a vehicle interior (for example, JP 2011-8762 A).

An object of the present disclosure is to provide an image generation apparatus and an image generation method capable of outputting an image in which a surrounding environment of a vehicle is easily grasped.

### SUMMARY

An image generation apparatus according to the present disclosure includes a processor that acquires a first image in which a surrounding environment of a vehicle imaged by an imaging apparatus provided in the vehicle is shown, generates, based on the first image, a plurality of second images corresponding to horizontal components viewed from a virtual viewpoint provided above the vehicle in a plurality of line-of-sight directions that are shifted in a direction of rotation around the vehicle and are different from each other, and switches and outputs the plurality of second images to a display device.

### BRIEF DESCRIPTION OF THE DRAWINGS

FIG. 1 is an external view of a vehicle including an image generation apparatus according to a first embodiment as viewed from above;

FIG. 2 is a diagram illustrating an example of a hardware configuration of the image generation apparatus according to the first embodiment;

FIG. 3 is a diagram for illustrating a virtual viewpoint for generating a surrounding image and a line-of-sight direction from the virtual viewpoint according to the first embodiment;

FIG. 4 is a diagram illustrating an example of a method of restricting height of a vehicle model by the image generation apparatus according to the first embodiment;

FIG. 5 is a diagram illustrating an example of a depression angle setting method according to the first embodiment;

FIG. 6 is a diagram illustrating an example of a surrounding image displayed on a display device by the image generation apparatus according to the first embodiment;

FIG. 7 is a flowchart illustrating an operation of outputting the surrounding image to the display device by the image generation apparatus according to the first embodiment;

FIG. 8 is a flowchart illustrating image generation processing according to the first embodiment;

FIG. 9 is a flowchart illustrating image generation processing according to a second embodiment;

FIG. 10 is a flowchart illustrating image generation processing according to a third embodiment;

FIG. 11 is a diagram illustrating an operation of moving in a virtual world, which is executed by the image generation apparatus according to a fourth embodiment;

FIG. 12 is a diagram illustrating an example of the surrounding image obtained by moving a virtual viewpoint;

FIG. 13 is a flowchart illustrating an operation of generating a vehicle model image, which is executed by the image generation apparatus according to a fifth embodiment;

FIG. 14 is a flowchart illustrating an operation for restricting the height of the vehicle model, which is executed by the image generation apparatus according to a sixth embodiment;

FIG. 15 is a diagram illustrating a method of restricting the height of the vehicle model, which is executed by the image generation apparatus according to a seventh embodiment;

FIG. 16 is a diagram illustrating a method of restricting the height of the vehicle model, which is executed by the image generation apparatus according to an eighth embodiment; and

FIG. 17 is a diagram illustrating a method of restricting the height of the vehicle model, which is executed by the image generation apparatus according to a ninth embodiment.

### DETAILED DESCRIPTION

Hereinafter, embodiments of the present disclosure are described in detail with reference to the drawings as appropriate. However, unnecessarily detailed description may be omitted. Note that the accompanying drawings and the following description are provided for those skilled in the art to fully understand the present disclosure and are not intended to limit the subject matter described in the claims.

### First Embodiment

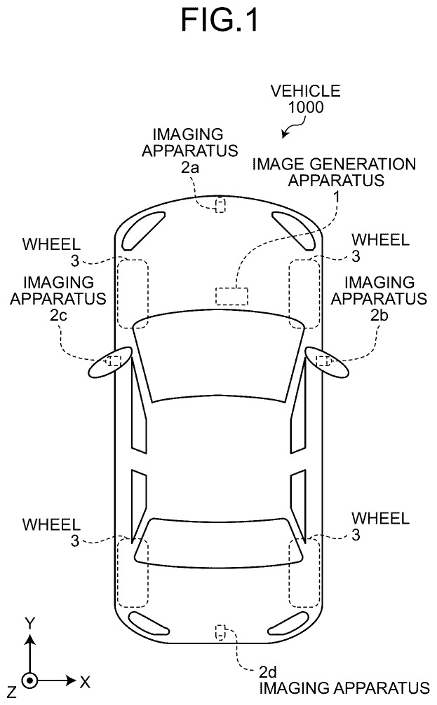

FIG. 1 is an external view of a vehicle 1000 including an image generation apparatus 1 according to a first embodiment as viewed from above. In some of the drawings subsequent to this drawing, coordinate axes are illustrated in which a front direction of the vehicle 1000 is a Y-axis direction, a right side direction of the vehicle 1000 is an X-axis direction, and an upper direction of the vehicle 1000 is a Z-axis direction. In addition, corresponding coordinate axes are also displayed in other drawings illustrating a vehicle model 200 (described below) which is a 3D model illustrating the vehicle 1000.

The vehicle 1000 is an automobile with a drive source such as an internal combustion engine or an electric motor. The vehicle 1000 includes a plurality of wheels 3 (here, four wheels 3), and one or more wheels 3 among the plurality of wheels 3 are driven by a drive source.

The vehicle 1000 includes a vehicle interior (not illustrated). Driving of the vehicle 1000 is controlled by an occupant in the vehicle interior. Note that a part or all of the driving control of the vehicle 1000 may be automated.

The vehicle 1000 is provided with a plurality of imaging apparatuses 2. In the first embodiment, as the plurality of imaging apparatuses 2, four of the imaging apparatuses 2a to 2d are provided to the vehicle 1000. Each imaging apparatus 2 is, for example, an imaging apparatus embedded with an imaging element such as a charge coupled device (CCD) or a CMOS image sensor (CIS). Each imaging apparatus 2 can output an image at a predetermined frame rate. Each imaging apparatus 2 includes a wide-angle lens or a fisheye lens. Therefore, each imaging apparatus 2 can image an area in a wide range in which the optical axis is directed. In addition, the optical axis of each imaging apparatus 2 is directed outward from the vehicle 1000 at least in plan view, so that each imaging apparatus 2 can image the surrounding environment including the road surface around the vehicle 1000.

Specifically, the imaging apparatus 2a is provided in a front part (for example, a front grille) of the vehicle 1000. The optical axis of the imaging apparatus 2a is directed in the vehicle front direction or slightly downward from the vehicle front direction. Therefore, the imaging apparatus 2a can image a wide area in front of the vehicle.

The imaging apparatus 2b is provided on a right side part (for example, a lower part of a right door mirror) of the vehicle 1000. The optical axis of the imaging apparatus 2b is directed in the vehicle right side direction or slightly downward from the vehicle right side direction. Therefore, the imaging apparatus 2b can image a wide area on the right side of the vehicle.

The imaging apparatus 2c is provided at a rear part (for example, a rear gate) of the vehicle 1000. The optical axis of the imaging apparatus 2c is directed in the vehicle rear direction or slightly downward from the vehicle rear direction. Therefore, the imaging apparatus 2c can image a wide area behind the vehicle.

The imaging apparatus 2d is provided on a left side of the vehicle 1000 (for example, a lower part of a left door mirror). The optical axis of the imaging apparatus 2d is in the vehicle left side direction or directed slightly downward from the vehicle left side direction. Therefore, the imaging apparatus 2d can image a wide area on the left side of the vehicle.

Note that the location where each imaging apparatus 2 is provided is not limited to the above example. As long as it is possible to image the surrounding environment of the vehicle 1000, the number of imaging apparatuses 2 provided in the vehicle 1000 and the locations of the imaging apparatuses 2 are any number and locations.

The vehicle 1000 is provided with the image generation apparatus 1. The image generation apparatus 1 may be, for example, one of a group of electronic control units (ECUs). The image generation apparatus 1 executes arithmetic processing and image processing based on images showing the surrounding environment imaged by the four imaging apparatuses 2 and outputs an image after the arithmetic processing and the image processing to the display device (a display device 5 described below) provided in the vehicle interior.

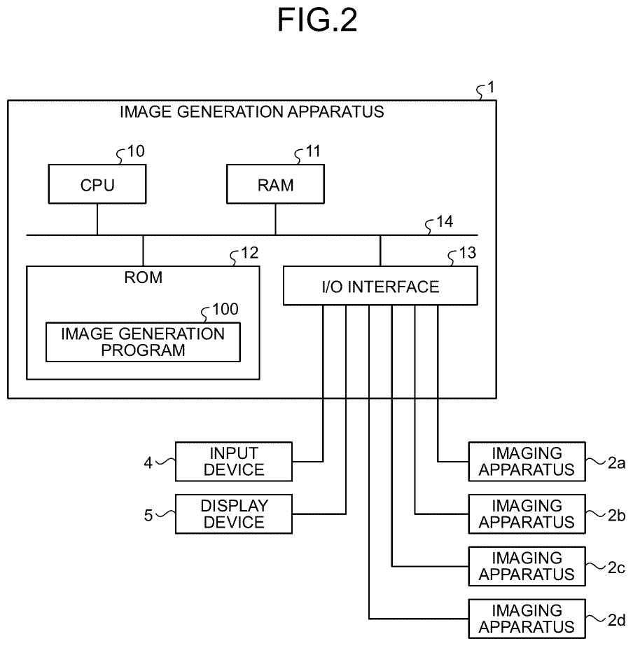

FIG. 2 is a diagram illustrating an example of a hardware configuration of the image generation apparatus 1 according to the first embodiment.

The imaging apparatuses 2a to 2d, an input device 4, and the display device 5 are connected to the image generation apparatus 1. Some or all of the imaging apparatuses 2a to 2d, the input device 4, and the display device 5 may be connected to the image generation apparatus 1 via a network such as a controller area network (CAN).

The input device 4 is provided in the vehicle interior. The input device 4 is a touch panel, a switch, a dial, a joystick, a push button, or the like. An occupant of the vehicle 1000 can input various instructions to the image generation apparatus 1 via the input device 4.

The display device 5 is provided in the vehicle interior. The display device 5 is, for example, a liquid crystal display (LCD) or an organic electroluminescent display (OELD). The display device 5 displays the image output from the image generation apparatus 1 so that the occupant can visually recognize the image.

The image generation apparatus 1 includes a central processing unit (CPU) 10, a random access memory (RAM) 11, a read only memory (ROM) 12, an input/output (I/O) interface 13, and a bus 14. The CPU 10, the RAM 11, the ROM 12, and the I/O interface 13 are electrically connected to the bus 14.

The I/O interface 13 is an interface for the image generation apparatus 1 to communicate data with an external device. Here, the external devices are the imaging apparatuses 2a to 2d, the input device 4, and the display device 5. Note that the image generation apparatus 1 may include the plurality of I/O interfaces 13, and the imaging apparatuses 2a to 2d, the input device 4, and the display device 5 may be connected to different I/O interfaces 13. In FIG. 2, in order to simplify the description, the image generation apparatus 1 includes one I/O interface 13 to which these devices are connected.

A computer program, parameters required for execution of the computer program, and the like are stored in the ROM 12. The RAM 11 temporarily stores various types of data used in the calculation in the CPU 10. The CPU 10 is a processor capable of executing a computer program.

Here, an image generation program 100 is stored in the ROM 12. The CPU 10 loads the image generation program 100 from the ROM 12 into the RAM 11 at a predetermined timing such as startup. Then, the CPU 10 implements the image generation method according to the first embodiment based on the image generation program 100 in the RAM 11.

In the first embodiment, the CPU 10 acquires an image showing the surrounding environment of the vehicle 1000 imaged by the imaging apparatuses 2a to 2d via the I/O interface 13. Then, based on the images acquired from the imaging apparatuses 2a to 2d, the CPU 10 generates a plurality of images corresponding to horizontal components viewed from a virtual viewpoint provided above the vehicle 1000 in a plurality of line-of-sight directions that are shifted in the direction of rotation around the vehicle 1000 and are different from each other. Then, the CPU 10 switches and outputs the plurality of generated images to the display device 5 via the I/O interface 13. The image generated by the CPU 10 is referred to as a surrounding image.

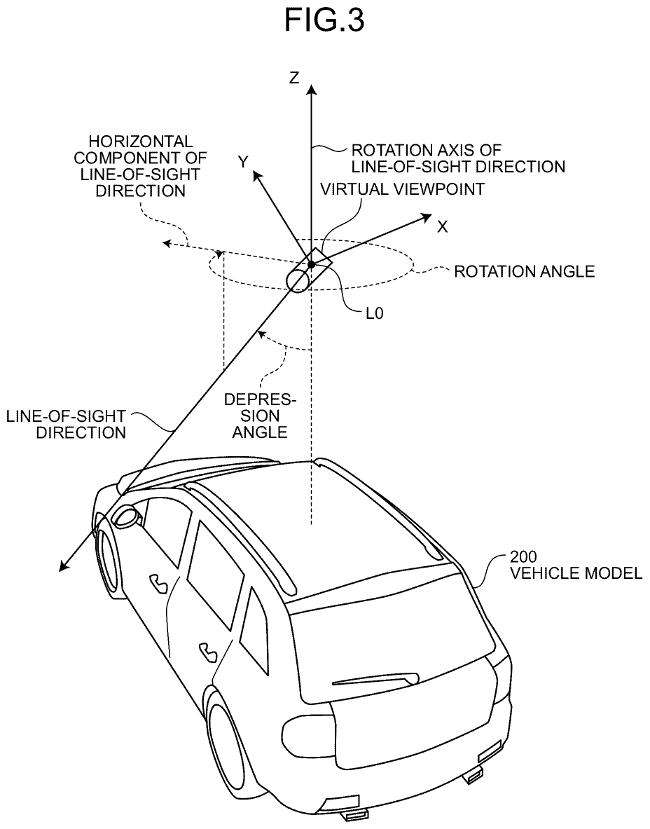

FIG. 3 is a diagram for illustrating a virtual viewpoint for generating a surrounding image and a line-of-sight direction from the virtual viewpoint according to the first embodiment.

When generating the surrounding image, the CPU 10 provides the vehicle model 200, which is a 3D model representing the vehicle 1000 on the virtual plane. Then, the CPU 10 provides a virtual viewpoint at a location L0 directly above the vehicle model 200.

The CPU 10 sets the line-of-sight direction from the virtual viewpoint to be directed outward from the vehicle model 200 in plan view. In other words, the CPU 10 sets the line-of-sight direction such that the horizontal components in the line-of-sight direction are directed from the vehicle model 200 outside the vehicle model 200.

The CPU 10 performs viewpoint conversion on each of the captured images acquired from the imaging apparatuses 2a to 2d based on the relationship between the location of the imaging apparatus 2 that has captured images and the location L0 of the virtual viewpoint. As a result, the CPU 10 generates an image of the surrounding environment viewed from the virtual viewpoint. Further, the CPU 10 superimposes an image of the vehicle model 200 (referred to as a vehicle model image) viewed from a virtual viewpoint on the generated image. The CPU 10 outputs, as the surrounding image, an image on which the vehicle model image is superimposed.

Further, the CPU 10 can rotate the line-of-sight direction about a straight line passing through the location L0 and extending in the Z-axis direction as a rotation axis. Then, the CPU 10 generates the surrounding image for each different line-of-sight direction and outputs the surrounding image to the display device 5. In other words, the CPU 10 generates the plurality of surrounding images corresponding to the horizontal components viewed in a plurality of line-of-sight directions that are shifted in the direction of rotation around the vehicle 1000 and are different from each other, switches and outputs the plurality of generated surrounding images to the display device 5.

As described above, the optical axes of the imaging apparatuses 2a to 2d are directed outward from the vehicle 1000 in plan view. Furthermore, as described with reference to FIG. 3, the line-of-sight direction from the virtual viewpoint is set so that the line-of-sight direction from the virtual viewpoint is directed outward from the vehicle model 200 in plan view. That is, according to the first embodiment, the directions of the optical axes of the imaging apparatuses 2a to 2d and the line-of-sight direction from the virtual viewpoint are identical to each other in that the directions are directed outward from the vehicle 1000 (the vehicle model 200) in plan view.

For comparison with the first embodiment, a case is considered in which the line-of-sight direction from the virtual viewpoint is directed from the outside of the vehicle model toward the vehicle model in plan view. The case is referred to as a comparative case. According to the comparative case, the line-of-sight direction from the virtual viewpoint is different from the direction of the optical axis of the imaging apparatus since the line-of-sight direction from the virtual viewpoint is directed in the direction of the vehicle (vehicle model) in plan view. Therefore, when there is a three-dimensional object around the vehicle, the three-dimensional object is shown to fall on the ground in the surrounding image.

Otherwise, according to the first embodiment, the directions of the optical axes of the imaging apparatuses 2a to 2d and the line-of-sight direction from the virtual viewpoint are identical to each other in that the directions are directed outward from the vehicle 1000 (the vehicle model 200) in plan view. Therefore, when there is a three-dimensional object around the vehicle 1000, the CPU 10 can generate a surrounding image in which the three-dimensional object is shown to stand from the ground. Therefore, according to the first embodiment, unlike the comparative case, it is possible to generate the surrounding image in which the occupant can grasp the three-dimensional object without discomfort.

Note that as illustrated in FIG. 3, in the present specification, an angle formed by the Y-axis positive direction and the line-of-sight direction in plan view is referred to as a rotation angle. Also, an angle formed by the Z-axis negative direction and the line-of-sight direction is referred to as a depression angle. Note that the definition of the rotation angle and the depression angle is an example.

The trigger of the action of rotating the line-of-sight direction is not limited to a specific event.

In one example, the CPU 10 may sequentially generate surrounding images while continuously changing the rotation angle in the positive direction or the negative direction at a constant angular velocity, and sequentially output the generated surrounding images to the display device 5.

In another example, the CPU 10 may change the line-of-sight direction based on an input from the occupant via the input device and generate and output the surrounding image each time the line-of-sight direction is changed.

The vehicle model 200 has a height corresponding to the vehicle 1000. Therefore, it is concerned that a part of the area in which the surrounding environment is shown in the viewpoint-converted image is hidden by the vehicle model image. A part hidden by the vehicle model image in the area where the surrounding environment is shown is referred to as road surface vignetting. Also, the square measure of the road surface vignetting is referred to as a road surface vignetting square measure.

When the road surface vignetting occurs, the occupant cannot confirm the situation of the road surface in the extreme vicinity of the vehicle 1000. Therefore, the CPU 10 limits the height of the vehicle model 200 when generating the vehicle model image in order to suppress the road surface vignetting square measure.

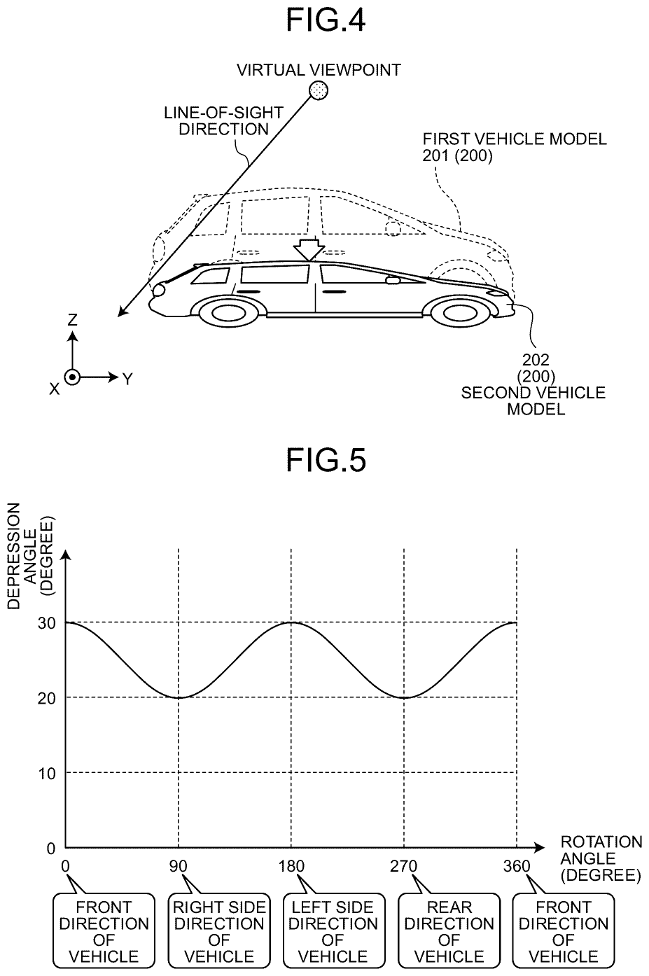

FIG. 4 is a diagram illustrating an operation of restricting the height of the vehicle model 200 by the image generation apparatus 1 of the first embodiment. As illustrated in the drawing, the CPU 10 uniformly compresses the dimension of the original vehicle model 200 in the Z-axis direction to generate the vehicle model 200 after height restriction.

Note that the vehicle model 200 before the height restriction is referred to as a first vehicle model 201. The vehicle model 200 after the height restriction is referred to as a second vehicle model 202.

In order for the occupant to more easily grasp the surrounding environment, it is desirable that a part of the vehicle 1000 (more accurately, the vehicle model 200) is shown in the surrounding image. For example, when there is an obstacle (person or object) around the vehicle 1000, if a part of the vehicle 1000 is shown in the surrounding image in addition to the obstacle, the occupant can easily grasp the positional relationship between the obstacle and the vehicle 1000.

However, when the square measure of the image of the vehicle model 200, that is, the vehicle model image is too large, the square measure of the area showing the surrounding environment becomes relatively small, and the information on the surrounding environment obtained by the occupant from the surrounding image decreases. Therefore, it is desirable that the balance between the square measure of the vehicle model image and the square measure of the area showing the surrounding environment is appropriate. This balance is referred to as a display balance.

A normal vehicle has an elongated shape extending in the front-rear direction (the Y-axis direction according to the example illustrated in FIG. 1). Therefore, when the depression angle is fixed, and the rotation angle is changed, the display balance changes according to the rotation angle. Specifically, in a case where the rotation angle is 90 degrees or 270 degrees corresponding to the right side direction or the left side direction of the vehicle 1000, the square measure of the area where the image of the vehicle model 200 is displayed decreases as compared with a case where the rotation angle is 0 degrees or 180 degrees corresponding to the front direction or the rear direction of the vehicle 1000.

Therefore, in the first embodiment, the CPU 10 changes the depression angle according to the rotation angle in the line-of-sight direction so that the above balance is maintained at an appropriate level as much as possible.

FIG. 5 is a diagram illustrating an example of a depression angle setting method according to the first embodiment. In the drawing, the horizontal axis indicates the rotation angle, and the vertical axis indicates the depression angle. Note that in the present specification, the numerical values of the rotation angle and the depression angle are expressed in units of degrees.

In the example illustrated in FIG. 5, when the rotation angle is 0 degrees or 180 degrees corresponding to the front direction or the rear direction of the vehicle 1000, the depression angle is set to the maximum value of 30 degrees. Also, when the rotation angle is 90 degrees or 270 degrees corresponding to the right side direction or the left side direction of the vehicle 1000, the depression angle is set to a minimum value of 20 degrees.

As described above, when the rotation angle is 90 degrees or 270 degrees corresponding to the right side direction or the left side direction of the vehicle 1000, the depression angle is reduced, so that a decrease in the square measure of the area where the image of the vehicle model 200 is displayed is suppressed. As a result, a change in balance between the square measure of the area where the image of the vehicle model 200 is displayed and the square measure of the area showing the surrounding environment is suppressed.

In the example illustrated in FIG. 5, the depression angle is smoothly changed in a sinusoidal shape with respect to the rotation angle. The change of the depression angle with respect to the rotation angle is not limited to a sinusoidal shape. The depression angle may be smoothly changed with respect to the rotation angle or may be changed stepwise with respect to the rotation angle. Note that when the depression angle is smoothly changed with respect to the rotation angle, the visibility for the occupant is improved as compared with the case where the depression angle is changed stepwise with respect to the rotation angle.

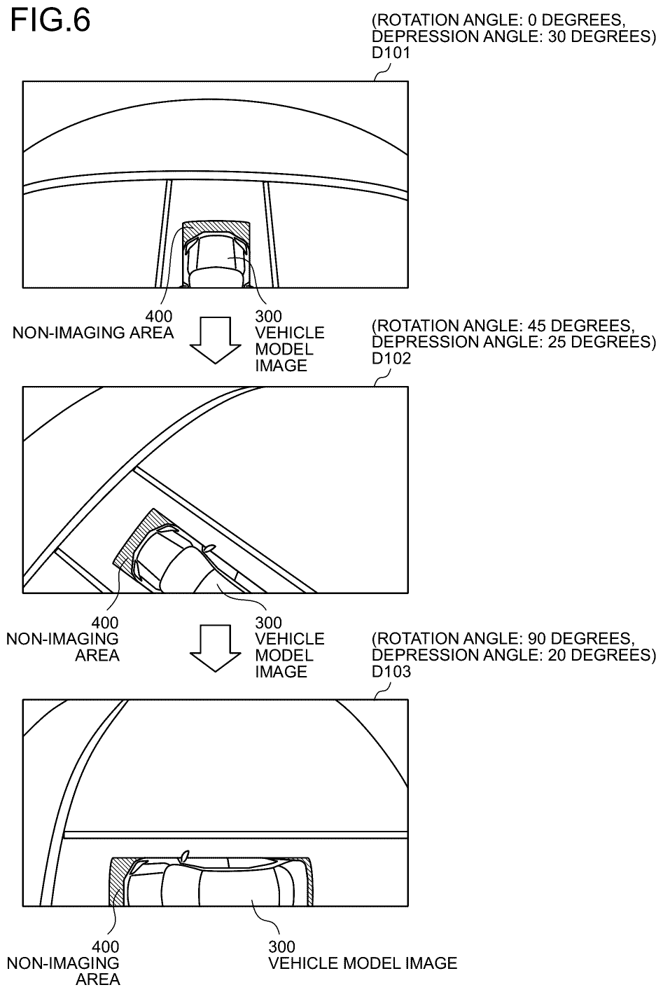

FIG. 6 is a diagram illustrating an example of the surrounding image displayed on the display device 5.

A surrounding image D101 is a surrounding image when the rotation angle is 0 degrees. A surrounding image D102 is a surrounding image when the rotation angle is 45 degrees. A surrounding image D103 is a surrounding image when the rotation angle is 90 degrees.

According to the example illustrated in FIG. 5, the set value of the depression angle when the rotation angle is 0 degrees is 30 degrees, the set value of the depression angle when the rotation angle is 45 degrees is 25 degrees, and the set value of the depression angle when the rotation angle is 90 degrees is 20 degrees. Therefore, the surrounding image D101 is generated at a depression angle of 30 degrees, the surrounding image D102 is generated at a depression angle of 25 degrees, and the surrounding image D103 is generated at a depression angle of 20 degrees.

From FIG. 6, it can be read that the display balance is maintained at an appropriate level in each of the surrounding image D101, the surrounding image D102, and the surrounding image D103.

Therefore, the occupant can easily grasp the positional relationship between the surrounding environment shown in the surrounding image and the vehicle 1000 regardless of the rotation angle.

In each imaging apparatus 2, there is a blind spot, that is, an area that cannot be imaged, on the vehicle 1000 side. Therefore, in the surrounding image, an image obtained from the captured image cannot be shown in a substantially rectangular area where the vehicle 1000 exists. A non-imaging area 400 illustrated in FIG. 6 is an area in which the image obtained from a captured image cannot be shown.

The road surface vignetting described above refers to a part where a vehicle model image 300 protrudes from the non-imaging area 400. In the first embodiment, the vehicle model image 300 is generated based on the vehicle model 200 after the height restriction, that is, the second vehicle model 202. Therefore, the square measure of the part where the vehicle model image 300 protrudes from the non-imaging area 400, that is, the road surface vignetting square measure can be suppressed.

Next, the operation of the image generation apparatus 1 according to the first embodiment is described.

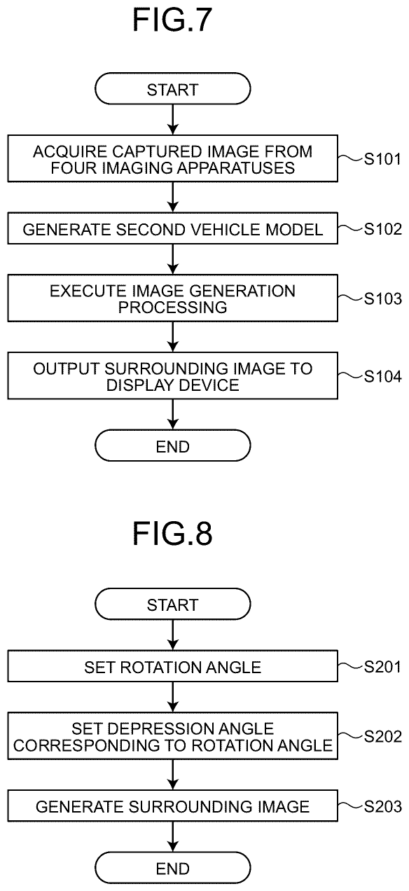

FIG. 7 is a flowchart illustrating an operation of outputting the surrounding image to the display device 5 by the image generation apparatus 1 according to the first embodiment. Here, as an example, an operation of outputting a surrounding image of one frame is described. That is, the series of operations illustrated in the drawing is repeatedly executed for each frame.

First, the CPU 10 acquires captured images from the four imaging apparatuses 2a to 2d via the I/O interface 13 (S101). The CPU 10 generates the second vehicle model 202 that is the vehicle model 200 of which a height is restricted (S102).

The CPU 10 executes image generation processing of generating a surrounding image (S103). Then, the CPU 10 outputs the generated surrounding image to the display device 5 via the I/O interface 13 (S104). Then, the operation for one frame ends.

FIG. 8 is a flowchart illustrating image generation processing according to the first embodiment.

The CPU 10 sets a rotation angle for generating a surrounding image (S201).

A method of setting the rotation angle is not limited to a specific method. In a case where the rotation angle is continuously changed at a constant angular velocity, the CPU 10 acquires the rotation angle for generating the current surrounding image by adding a value of a predetermined pitch to the rotation angle used when the surrounding image of the previous frame is generated. When the rotation angle is designated by an instruction from the occupant, the CPU 10 sets the designated rotation angle as the rotation angle for generating the surrounding image.

Subsequent to S201, the CPU 10 sets the depression angle corresponding to the rotation angle set by the processing of S201 (S202). For example, the CPU 10 acquires the depression angle corresponding to the rotation angle based on the correspondence relationship illustrated in FIG. 5 and sets the depression angle as the depression angle for generating the surrounding image.

The CPU 10 generates the surrounding image by using the four captured images acquired from the four imaging apparatuses 2a to 2d by the processing of S101, the second vehicle model 202 generated by the processing of S102, and the line-of-sight direction determined by the rotation angle and the depression angle acquired by the processing of S201 and S202 (S203). Then, the image generation processing ends.

As described above, according to the first embodiment, the CPU 10 acquires the image showing the surrounding environment of the vehicle 1000 imaged by the imaging apparatuses 2a to 2d provided in the vehicle 1000 via the I/O interface 13. Then, based on the images acquired from the imaging apparatuses 2a to 2d, the CPU 10 generates the plurality of surrounding images corresponding to the horizontal components obtained by viewing the surrounding environment of the vehicle 1000 from the virtual viewpoint provided above the vehicle 1000 in the plurality of line-of-sight directions that are shifted in the direction of rotation around the vehicle 1000 and are different from each other. Then, the CPU 10 switches and outputs the plurality of surrounding images to the display device 5 via the I/O interface 13.

The directions of the optical axes of the imaging apparatuses 2a to 2d and the line-of-sight direction from the virtual viewpoint are identical to each other in that the directions are directed outward from the vehicle 1000 (vehicle model 200) in plan view. Therefore, the CPU 10 can generate a surrounding image in which the occupant can grasp a three-dimensional object around the vehicle 1000 without discomfort. That is, the image generation apparatus 1 can output an image in which the surrounding environment of the vehicle 1000 is easily grasped.

In addition, according to the first embodiment, the CPU 10 sets the depression angle so that a part of the vehicle model 200 is shown in each surrounding image.

Therefore, when there is an obstacle around the vehicle 1000, the occupant can easily grasp the positional relationship between the vehicle 1000 and the obstacle.

In addition, the CPU 10 sets the depression angle so as to change in a sinusoidal shape with respect to the rotation angle.

Since the depression angle smoothly changes with respect to the rotation angle, the visibility by the occupant is improved.

In addition, the CPU 10 restricts the height of the vehicle model 200 when generating the vehicle model image.

Therefore, it is possible to output a surrounding image in which the occupant can confirm the situation of the road surface in the extreme vicinity of the vehicle 1000.

### Second Embodiment

In a second embodiment, the CPU 10 sets the depression angle so that the display balance, that is, the balance between the square measure of the vehicle model image and the square measure of the area showing the surrounding environment is more strictly constant. Specifically, the target range of the square measure of the vehicle model image occupying the surrounding image is set in advance, and the CPU 10 sets the depression angle so that the square measure of the vehicle model image occupying the surrounding image falls within the target range.

In the following description of the second embodiment, matters different from those of the first embodiment are described. The same matters as those of the first embodiment are not described or briefly described.

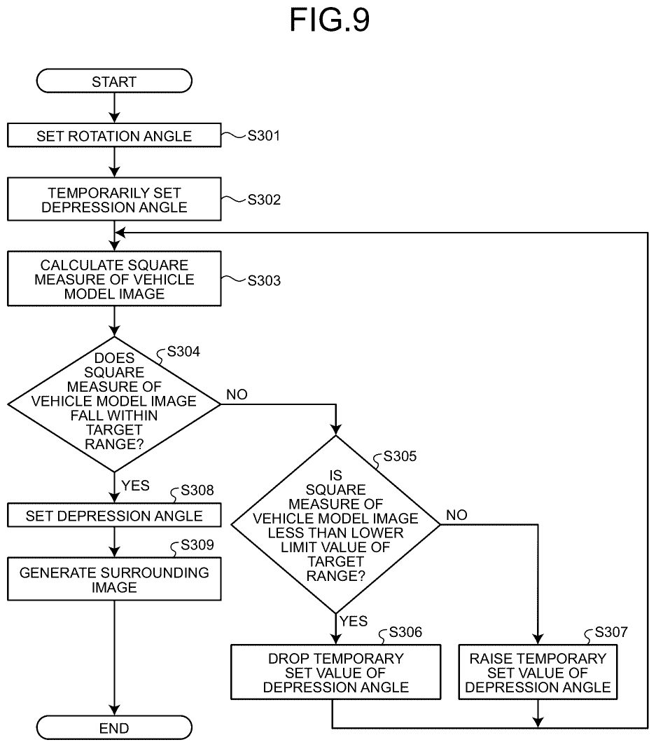

FIG. 9 is a flowchart illustrating image generation processing according to the second embodiment.

First, the CPU 10 sets a rotation angle for generating a surrounding image (S301). In S301, the CPU 10 sets the rotation angle in the same method as in S201.

Subsequently, the CPU 10 temporarily sets the depression angle (S302). In S302, the CPU 10 may set the depression angle used when the surrounding image of the previous frame is generated as a temporary set value. Alternatively, when the initial value of the depression angle is set in advance, the CPU 10 may set the initial value of the depression angle as the temporary set value of the depression angle.

Subsequently, the CPU 10 calculates the square measure of the vehicle model image in the surrounding image when the surrounding image is generated by using the line-of-sight direction determined by the temporary set values of the rotation angle and the depression angle (S303). Then, the CPU 10 determines whether the square measure of the vehicle model image obtained by the calculation falls within a preset target range (S304). The target range of the square measure of the vehicle model image may be set in advance by a designer or may be settable by an occupant.

When the square measure of the vehicle model image does not fall within the target range (S304: No), the CPU 10 determines whether the square measure of the vehicle model image is less than the lower limit value of the target range (S305).

When the square measure of the vehicle model image is less than the lower limit value of the target range (S305: Yes), the CPU 10 drops the temporary set value of the depression angle, for example, by a predetermined amount (S306).

When the square measure of the vehicle model image is not less than the lower limit value of the target range (S305: No), that is, when the square measure of the vehicle model image exceeds the upper limit value of the target range, the CPU 10 raises the temporary set value of the depression angle, for example, by a predetermined amount (S307).

After S306 or S307, the control transitions to S303, and the CPU 10 recalculates the square measure of the vehicle model image by using the temporary set value of the depression angle after adjustment.

When it is determined that the square measure of the vehicle model image falls within the target range in the determination processing of S304 (S304: Yes), the CPU 10 sets the temporary set value of the depression angle as the depression angle used for generating the surrounding image (S308).

The CPU 10 generates a surrounding image by using the four captured images acquired from the four imaging apparatuses 2a to 2d by the processing of S101, the second vehicle model 202 generated by the processing of S102, and the line-of-sight direction determined by the rotation angle set by the processing of S301 and the depression angle determined by the processing of S308 (S309). Then, the image generation processing according to the second embodiment ends.

Note that in the above description, the CPU 10 adjusts the depression angle based on the square measure of the vehicle model 200 shown in the surrounding image every time the image generation processing is performed. The correspondence relationship between the rotation angle and the depression angle may be stored in advance in a predetermined storage area of the image generation apparatus 1 so that the square measure of the vehicle model image is within the target range. Then, in the image generation processing, the CPU 10 may set the depression angle used for generating the surrounding image based on the correspondence relationship. The CPU 10 may acquire the correspondence relationship in advance by executing the processing of S302 to S308 for each set value different from each other in the rotation angle.

As described above, in the second embodiment, the CPU 10 sets the depression angle based on the square measure of the vehicle model 200 shown in the surrounding image.

Therefore, since the display balance is controlled to be constant regardless of the rotation angle, the information amount of the surrounding environment obtained by the occupant from the surrounding image can be made constant regardless of the rotation angle.

### Third Embodiment

In a third embodiment, the CPU 10 sets the depression angle so that at least a part of the dimension of the area in which the vehicle model image included in the surrounding image is shown is constant, thereby making the display balance as constant as possible. Here, as an example, the CPU 10 sets the depression angle so that the length in the vertical direction in the surrounding image is constant among the dimensions of the area in which the vehicle model image is shown.

In the following description of the third embodiment, matters different from those of the second embodiment are described. The same matters as those of the second embodiment are not described or briefly described.

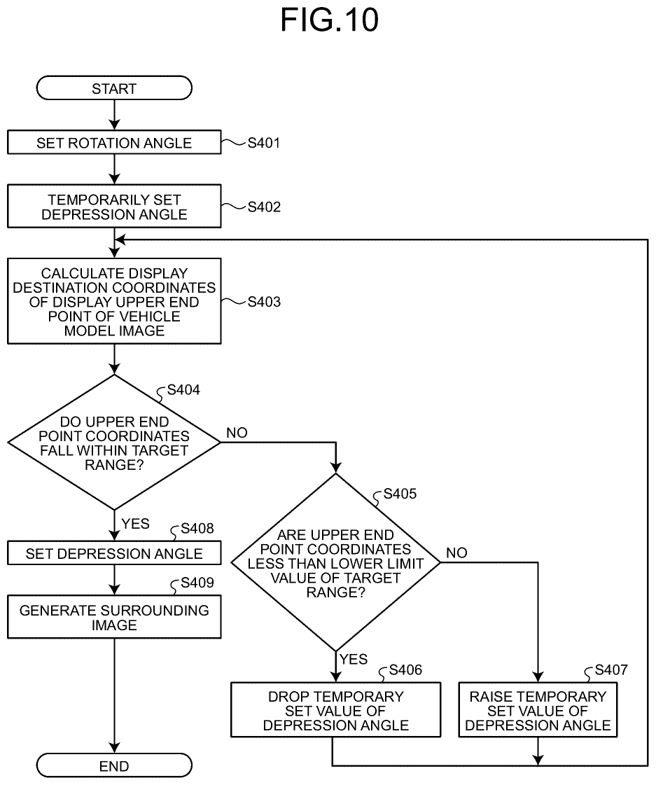

FIG. 10 is a flowchart illustrating image generation processing according to the third embodiment.

Similarly to S301 and S302, the CPU 10 sets the rotation angle for generating the surrounding image (S401) and temporarily sets the depression angle (S402).

Subsequently, the CPU 10 calculates display destination coordinates of the upper end point of the vehicle model image in the surrounding image when the surrounding image is generated by using the line-of-sight direction determined by the temporary set values of the rotation angle and the depression angle (S403). Then, the CPU 10 determines whether the coordinates of the upper end point obtained by the calculation fall within the target range (S404).

In the third embodiment, a range of coordinates of the upper end point of the vehicle model image in which the display balance can be set to an appropriate level is set in advance as the target range. The target range of the coordinates of the upper end point may be set by a designer or may be settable by an occupant.

When the coordinates of the upper end point do not fall within the target range (S404: No), the CPU 10 determines whether the coordinates of the upper end point are less than the lower limit value of the target range (S405).

When the coordinates of the upper end point are less than the lower limit value of the target range (S405: Yes), the CPU 10 raises the temporary set value of the depression angle, for example, by a predetermined amount (S406).

When the coordinates of the upper end point are not less than the lower limit value of the target range (S405: No), that is, when the coordinates of the upper end point exceed the upper limit value of the target range, the CPU 10 raises the temporary set value of the depression angle, for example, by a predetermined amount (S407).

After S406 or S407, the control transitions to S403, and the CPU 10 recalculates the coordinates of the display destination of the upper end point of the vehicle model image by using the temporary set value of the depression angle after adjustment.

When it is determined that the coordinates of the upper end point of the vehicle fall within the target range in the determination processing of S404 (S404: Yes), the CPU 10 determines the temporary set value of the depression angle as the depression angle used for generating the surrounding image (S408).

The CPU 10 generates a surrounding image by using the four captured images acquired from the four imaging apparatuses 2a to 2d by the processing of S101, the second vehicle model 202 generated by the processing of S102, and the line-of-sight direction determined by the rotation angle set by the processing of S401 and the depression angle determined by the processing of S408 (S409). Then, the image generation processing according to the third embodiment ends.

Note that in the above description, the CPU 10 adjusts the depression angle based on the dimensions of the vehicle model 200 shown in the surrounding image. The correspondence relationship between the rotation angle and the depression angle may be stored in advance in a predetermined storage area of the image generation apparatus 1 so that the dimension of the vehicle model 200 shown in the surrounding image falls within the target range. Then, in the image generation processing, the CPU 10 may acquire the depression angle used for generating the surrounding image based on the correspondence relationship. The CPU 10 may acquire the correspondence relationship in advance by executing the processing of S402 to S408 for each set value different from each other in the rotation angle.

As described above, in the third embodiment, the CPU 10 sets the depression angle based on the dimension of the vehicle model 200 shown in the surrounding image.

Therefore, similarly to the second embodiment, since the display balance is controlled to be constant regardless of the rotation angle, the information amount of the surrounding environment obtained by the occupant from the surrounding image can be made constant regardless of the rotation angle.

### Fourth Embodiment

According to the first to third embodiments, the CPU 10 sets the depression angle so that a part of the vehicle model 200 is shown in each surrounding image. The method for making a part of the vehicle model 200 be shown in each surrounding image is not limited thereto.

In a fourth embodiment, an example of moving the location of the virtual viewpoint is described as a variation of the method for making a part of the vehicle model 200 be shown in each surrounding image.

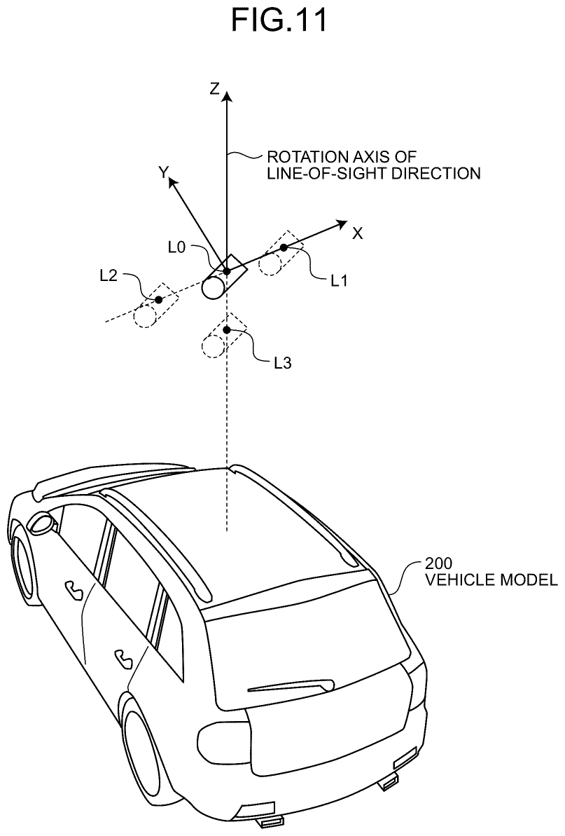

FIG. 11 is a diagram illustrating an operation of moving in a virtual world, which is executed by the image generation apparatus 1 according to the fourth embodiment. As illustrated in the drawing, the CPU 10 moves the location of the virtual viewpoint instead of the operation of changing the depression angle.

The CPU 10 may move the virtual viewpoint in the lateral direction with respect to the vehicle 1000 above the vehicle 1000 (more precisely, the vehicle model 200). A location L1 and a location L2 are examples of the location of the movement destination when the virtual viewpoint is moved in the lateral direction with respect to the vehicle 1000.

Alternatively, the CPU 10 may move the virtual viewpoint in the vertical direction (in other words, the X-axis direction) with respect to the vehicle 1000 above the vehicle 1000. A location L3 is an example of the location of the movement destination when the virtual viewpoint is moved in the vertical direction with respect to the vehicle 1000.

A correspondence relationship between the rotation angle and the location of the virtual viewpoint is set in advance, and the CPU 10 may move the virtual viewpoint based on the correspondence relationship.

Alternatively, the CPU 10 may move the virtual viewpoint based on the square measure of the vehicle model 200 shown in the surrounding image.

Alternatively, the CPU 10 may move the virtual viewpoint based on the dimension of the vehicle model 200 shown in the surrounding image.

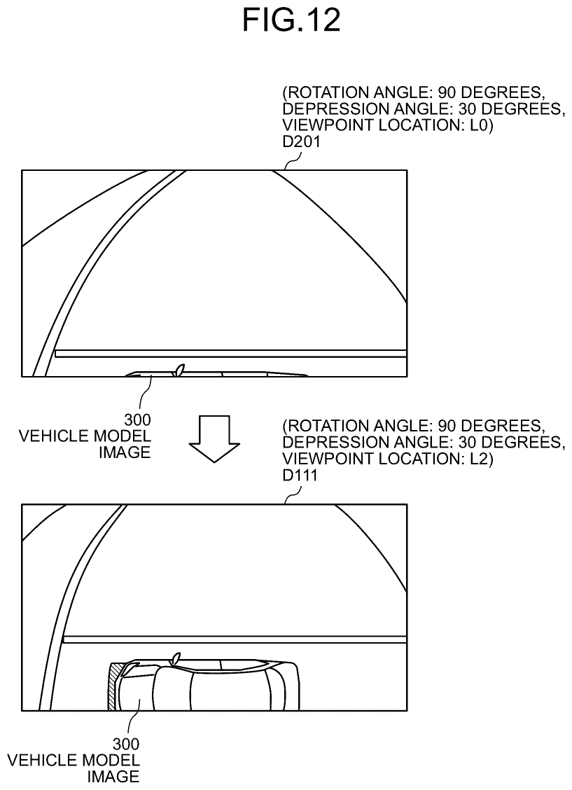

FIG. 12 is a diagram illustrating an example of the surrounding image obtained by moving a virtual viewpoint. Note that, here, the surrounding images before and after the movement of the virtual viewpoint when the control to move the virtual viewpoint is executed based on the square measure of the vehicle model 200 shown in the surrounding image are illustrated.

A surrounding image D201 is a surrounding image generated based on the setting before the virtual viewpoint is moved. Specifically, the surrounding image D201 is a surrounding image generated when the rotation angle is set to 90 degrees, the depression angle is set to 30 degrees, and the virtual viewpoint is set to L0. According to the surrounding image D201, since the square measure of the area in which the vehicle model image 300 is shown is significantly small, it is difficult for the occupant to grasp the positional relationship between the vehicle 1000 and the surrounding environment.

The surrounding image D211 is a surrounding image generated based on the setting after the virtual viewpoint is moved. Specifically, a surrounding image D111 is a surrounding image generated when the rotation angle is set to 90 degrees, the depression angle is set to 30 degrees, and the virtual viewpoint is set to L2. According to the surrounding image D111, the square measure of the area in which the vehicle model image 300 is shown is larger than that of the surrounding image D201, and it can be understood that the display balance is greatly improved.

As described above, the CPU 10 may set the viewpoint location according to the line-of-sight direction so that a part of the vehicle model 200 is shown in each surrounding image.

### Fifth Embodiment

In a fifth embodiment, a variation of an operation when a vehicle model image is generated is described. The operation of the fifth embodiment can be used in combination with the operations of the first to fourth embodiments.

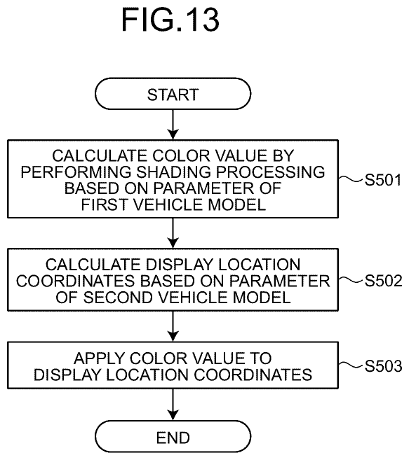

FIG. 13 is a flowchart illustrating an operation of generating a vehicle model image, which is executed by the image generation apparatus 1 according to the fifth embodiment.

First, the CPU 10 calculates a color value of the first vehicle model 201 by performing shading processing based on the parameters of the first vehicle model 201 (S501). The shading processing is processing of performing shading in consideration of a degree of light exposure and the like. The parameters of the first vehicle model 201 include coordinates of a large number of polygon vertices that define the shape of the first vehicle model 201. That is, in S501, the CPU 10 calculates the color value after the shading based on the shape of the vehicle model 200 before the height restriction.

The CPU 10 calculates display location coordinates in the surrounding image based on the parameters of the second vehicle model 202 (S502).

The CPU 10 applies the color value obtained by the calculation of S501 to the display location coordinates of the second vehicle model 202 (S503) and ends the operation of generating the vehicle model image.

As described above, the CPU 10 applies the color value after the shading to the vehicle model 200 after the height restriction based on the shape of the vehicle model 200 before the height restriction.

Therefore, it is possible to suppress loss of stereoscopic effect due to the height restriction.

Note that the color value after the shading may be calculated in advance based on the shape of the vehicle model 200 before the height restriction and applied to the vehicle model 200 after the height restriction.

### Sixth Embodiment

In a sixth embodiment, a variation of the operation of restricting the height of the vehicle model 200 is described. The operation of the sixth embodiment is applicable to any of the first to fifth embodiments.

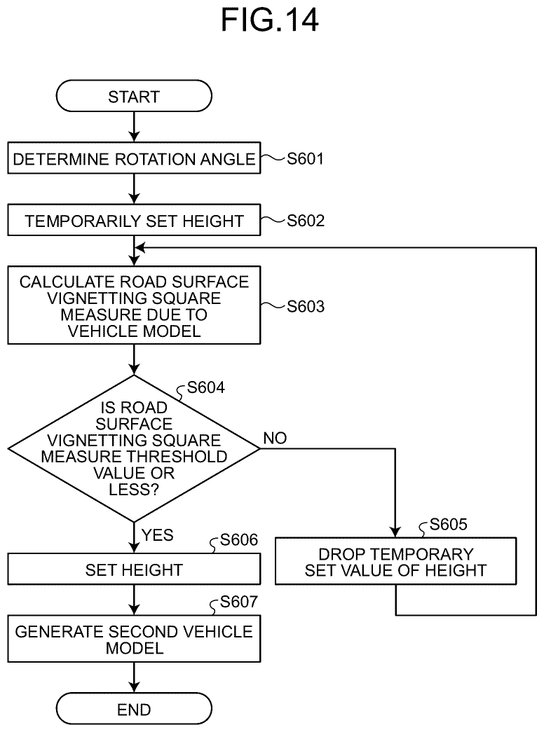

FIG. 14 is a flowchart illustrating an operation for restricting the height of the vehicle model 200, which is executed by the image generation apparatus 1 according to the sixth embodiment.

First, when setting the rotation angle in the image generation processing (S601), the CPU 10 temporarily sets the height of the vehicle model 200 (S602). In S602, the CPU 10 may set the height used when the surrounding image of the previous frame is generated as a temporary set value. Alternatively, when the initial value of the height is set in advance, the CPU 10 may set the initial value as the temporary set value of the height.

Subsequently, the CPU 10 calculates the road surface vignetting square measure when the surrounding image is generated by using the temporary set values of the set rotation angle and the set height (S603). Then, the CPU 10 determines whether the road surface vignetting square measure is the threshold or less (S604). The threshold is preset. The threshold value may be set by a designer or may be settable by an occupant.

When the road surface vignetting square measure is not the threshold value or less (S604: No), the temporary set value of the height is dropped, for example, by a predetermined amount (S605). Also, the control transitions to S603, and the CPU 10 recalculates the square measure of the vehicle model image by using the temporary set value of the height after adjustment.

When the road surface vignetting square measure is the threshold or less (S604: Yes), the CPU 10 determines the temporary set value as the height to be used for height restriction (S606). Then, the CPU 10 generates the second vehicle model 202 by using the determined height (S607), and ends the operation of restricting the height of the vehicle model 200.

In the above description, the CPU 10 adjusts the height of the vehicle model 200 based on the road surface vignetting square measure. A correspondence relationship between a rotation angle and a height which causes the road surface vignetting square measure to be a threshold value or less may be stored in advance in a predetermined storage area of the image generation apparatus 1. Then, in the image generation processing, the CPU 10 may acquire the height to be used for the height restriction based on the correspondence relationship. The CPU 10 may acquire the correspondence relationship in advance by executing the processing of S602 to S606 for each set value different from each other in the rotation angle.

In this manner, the CPU 10 may set the height of the vehicle model 200 based on the road surface vignetting square measure.

### Seventh Embodiment

In a seventh embodiment, another variation of the operation of restricting the height of the vehicle model 200 is described. The operation of the seventh embodiment is applicable to any of the first to fifth embodiments.

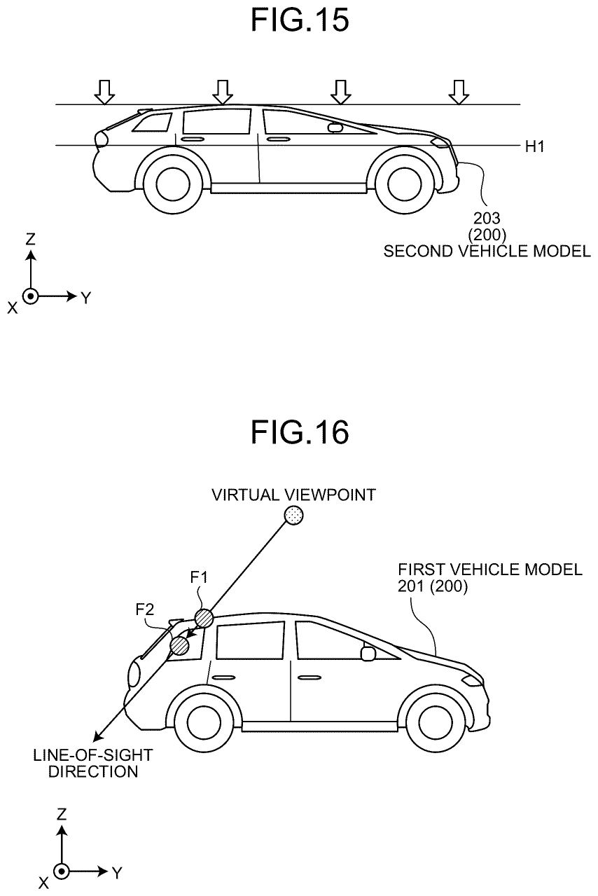

FIG. 15 is a diagram illustrating a method of restricting the height of the vehicle model 200, which is executed by the image generation apparatus 1 according to the seventh embodiment. The CPU 10 compresses the body above the wheels of the vehicle model 200 to generate a second vehicle model 203, which is the vehicle model 200 after the height restriction. In the example illustrated in the drawing, the CPU 10 compresses a part of the body in a range above a certain location H1 higher than the wheel.

The image generation apparatus 1 may change and display the steering angles of the wheels included in the vehicle model 200 according to the actual steering angles so that the occupant can confirm the states of the wheels 3. Alternatively, the image generation apparatus 1 may display the body of the vehicle model 200 so that the wheels hidden by the body can be visually recognized through the body by displaying the body in a translucent manner or displaying only the outline. In a case where these configurations are adopted, if the entire body including the wheels is uniformly compressed, the shape of the wheels shown in the surrounding image becomes elliptical when the actual steering angle is not 0 degrees, and it is concerned that the occupant feels discomfort.

In the seventh embodiment, the CPU 10 compresses the body above the wheels and does not compress the wheels. Therefore, it is possible to prevent the shape of the wheels that can be shown in the surrounding image from becoming elliptical.

### Eighth Embodiment

In an eighth embodiment, still another variation of the operation of restricting the height of the vehicle model 200 is described. The operation of the eighth embodiment is applicable to any of the first to fifth embodiments.

FIG. 16 is a diagram illustrating a method of restricting the height of the vehicle model 200, which is executed by the image generation apparatus 1 according to the eighth embodiment.

The CPU 10 moves the polygon vertex of the vehicle model 200 along a straight line extending from the virtual viewpoint. In the example illustrated in FIG. 16, the line-of-sight direction is illustrated as an example of a straight line extending from the virtual viewpoint. Then, a vertex F1, which is a polygon vertex of the vehicle model 200 on a straight line in the line-of-sight direction, is moved to a location of F2. The CPU 10 generates the vehicle model 200 after height restriction, that is, the second vehicle model 202 by uniformly moving all polygon vertices included in the vehicle model 200 by the above method.

In the first embodiment, the CPU 10 restricts the height of the vehicle model 200 by uniformly compressing the entire vehicle model 200. When the height is restricted by such a method, the appearance of the vehicle model 200 viewed from the virtual viewpoint changes before and after the height restriction, and it is concerned that the occupant feels discomfort.

In the eighth embodiment, the polygon vertex of the vehicle model 200 is moved along a straight line extending from the virtual viewpoint. As a result, the appearance of the vehicle model 200 viewed from the virtual viewpoint can be prevented from changing before and after the height restriction.

### Ninth Embodiment

In a ninth embodiment, still another variation of the operation of restricting the height of the vehicle model 200 is described. The operation of the ninth embodiment is applicable to any of the first to fifth embodiments.

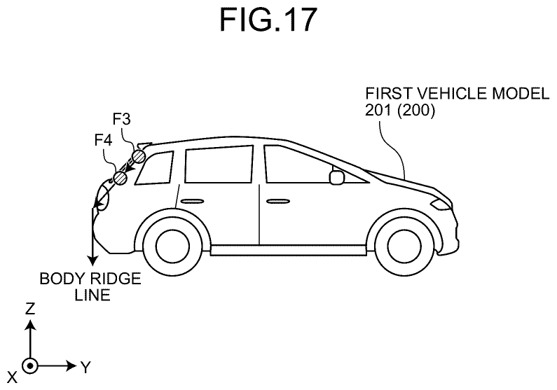

FIG. 17 is a diagram illustrating a method of restricting the height of the vehicle model 200, which is executed by the image generation apparatus 1 according to the ninth embodiment.

The CPU 10 moves the polygon vertex of the vehicle model 200 along the body ridge line of the vehicle model 200. For example, the CPU 10 moves a certain vertex F3 to a location of F4 along the body ridge line. The CPU 10 generates the vehicle model 200 after height restriction, that is, the second vehicle model 202 by uniformly moving all polygon vertices included in the vehicle model 200 by the above method.

When the height restriction is performed by moving the polygon vertex of the vehicle model 200 along the body ridge line, as in the eighth embodiment, the appearance of the vehicle model 200 viewed from the virtual viewpoint can be prevented from changing before and after the height restriction.

The image generation program 100, which is a computer program executed by the image generation apparatus 1 of the first to eighth embodiments, is stored in advance in the ROM 12 of the image generation apparatus 1. The image generation program 100 may be provided by being recorded in a computer-readable recording medium such as a compact disc (CD)-read only memory (ROM), a flexible disc (FD), a CD-recordable (R), a digital versatile disk (DVD), a universal serial bus (USB) memory, and a secure digital (SD) card as a file in an installable format or an executable format.

Furthermore, the image generation program 100 may be provided by being stored on a computer connected to a network such as the Internet and downloaded via the network.

A part or all of the processing executed by the CPU 10 according to the image generation program 100 may be realized by a field-programmable gate array (FPGA), an application specific integrated circuit (ASIC), a graphics processing unit (GPU), or the like.

According to the present disclosure, it is possible to provide an image generation apparatus and an image generation method capable of outputting an image in which a surrounding environment of a vehicle is easily grasped.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image generation apparatus comprising
a processor that acquires a first image in which a surrounding environment of a vehicle imaged by an imaging apparatus provided in the vehicle is shown, generates, based on the first image, a plurality of second images corresponding to horizontal components viewed from a virtual viewpoint provided above the vehicle in a plurality of line-of-sight directions that are shifted in a direction of rotation around the vehicle and are different from each other, and switches and outputs the plurality of second images to a display device.

2. The image generation apparatus according to claim 1,
wherein the processor sets depression angles of the plurality of line-of-sight directions such that a part of a vehicle model indicating the vehicle is shown in the plurality of second images.

3. The image generation apparatus according to claim 1,
wherein the processor sets depression angles of the plurality of line-of-sight directions so as to smoothly change with respect to a direction of the horizontal components of the plurality of line-of-sight directions.

4. The image generation apparatus according to claim 2,
wherein the processor sets the depression angles of the plurality of line-of-sight directions, based on a square measure of an area in which the vehicle model is shown in the plurality of second images.

5. The image generation apparatus according to claim 2,
wherein the processor sets the depression angles of the plurality of line-of-sight directions, based on a dimension of an area in which the vehicle model is shown in the plurality of second images.

6. The image generation apparatus according to claim 1,
wherein the processor sets a location of the virtual viewpoint for each of the plurality of line-of-sight directions such that a part of a vehicle model indicating the vehicle is shown in the plurality of second images.

7. The image generation apparatus according to claim 1,
wherein the processor
generates a vehicle model image based on a three-dimensional vehicle model corresponding to the vehicle,
displays the vehicle model image to be superimposed on each of the plurality of second images, and
restricts a height of the vehicle model when generating the vehicle model image.

8. The image generation apparatus according to claim 7,
wherein the processor calculates a color value of the vehicle model by executing shading processing on the vehicle model before height restriction, and applies the color value to the vehicle model after the height restriction.

9. The image generation apparatus according to claim 7,
wherein the processor compresses a body above a wheel with respect to the vehicle model to restrict the height of the vehicle model.

10. The image generation apparatus according to claim 7,
wherein the processor restricts the height of the vehicle model by moving a polygon vertex of the vehicle model along a straight line extending from the virtual viewpoint.

11. An image generation method comprising:
acquiring a first image in which a surrounding environment of a vehicle imaged by an imaging apparatus provided in the vehicle is shown;
generating, based on the first image, a plurality of second images corresponding to horizontal components viewed from a virtual viewpoint provided above the vehicle in a plurality of line-of-sight directions that are shifted in a direction of rotation around the vehicle and are different from each other; and
switching and outputting the plurality of second images to a display device.

12. The image generation method according to claim 11, further comprising
setting depression angles of the plurality of line-of-sight directions such that a part of a vehicle model indicating the vehicle is shown in the plurality of second images.

13. The image generation method according to claim 11, further comprising
setting depression angles of the plurality of line-of-sight directions so as to smoothly change with respect to a direction of the horizontal components of the plurality of line-of-sight directions.

14. The image generation method according to claim 12, further comprising
setting depression angles of the plurality of line-of-sight directions, based on a square measure of an area in which the vehicle model is shown in the plurality of second images.

15. The image generation method according to claim 12, further comprising
setting depression angles of the plurality of line-of-sight directions, based on a dimension of an area in which the vehicle model is shown in the plurality of second images.

16. The image generation method according to claim 11, further comprising
setting a location of the virtual viewpoint for each of the plurality of line-of-sight directions such that a part of a vehicle model indicating the vehicle is shown in the plurality of second images.

17. The image generation method according to claim 11, further comprising:
generating a vehicle model image based on a three-dimensional vehicle model corresponding to the vehicle;
displaying the vehicle model image to be superimposed on each of the plurality of second images; and
restricting a height of the vehicle model when generating the vehicle model image.

18. The image generation method according to claim 17, further comprising
calculating a color value of the vehicle model by executing shading processing on the vehicle model before height restriction and applying the color value to the vehicle model after the height restriction.

19. The image generation method according to claim 17,
wherein restricting the height of the vehicle model is restricting the height of the vehicle model by compressing a body above a wheel with respect to the vehicle model.

20. The image generation method according to claim 17,
wherein restricting the height of the vehicle model is restricting the height of the vehicle model by moving a polygon vertex of the vehicle model along a straight line extending from the virtual viewpoint.
